(19) United States
(12) Patent Application Publication
(10) Pub. No.: US 2007/0251970 A1
(43) Pub. Date: Nov. 1, 2007

(54) Spring-loaded desktop stapler with interchangeable staple cartridges

(76) Inventor: Pamela L. Cox, Christiansted, VI (US)

Correspondence Address: Pamela Cox, Unit 330, St. "C" Condo, Christiansted, VI, 00820, US

(21) Appl. No.: 11/711,547

(22) Filed: May 16, 2007

Related U.S. Application Data
(60) Provisional application No. 60/777,416, filed on Feb. 28, 2006.

(51) Int. Cl. B25C 5/06

(52) U.S. Cl. 227/120

(57) ABSTRACT

A spring-loaded desktop stapler as described above.

### FIELD OF THE INVENTION

The present invention relates to an improved spring-loaded desktop stapler with interchangeable staple cartridges that can handle all stapling needs.

### BACKGROUND OF THE INVENTION

Conventional desktop staplers comprise a staple driver that is linked directly to a handle, and a track for loading a strip of staples, so that pressing the handle ejects a staple out and through a stack of papers. Such conventional staplers typically staple up to only 20 pieces of paper, require a considerable amount of force to press the handle down, and are prone to jamming. In addition, the track in conventional desktop staplers is adapted to receive staples of only one length. Thus, more than one stapler must be used to staple stacks of paper having a variety of sizes.

A need therefore exists for an improved desktop stapler that takes minimal effort to use and is adaptable for a variety of paper stack sizes.

### SUMMARY OF THE INVENTION

The invention answers this need by providing a spring-loaded desktop stapler that uses a set of staple cartridges, sized to accommodate various stapling needs, which are interchangeably received by a chamber within a housing body of the stapler. The plurality of staple cartridges allows each cartridge to be used with a single stapler. Thus, by stocking a set or sets of the replaceable and interchangeable cartridges, only a small inventory of the staplers is required. With just a single stapler, a variety of cartridges, each having a different staple size, are available to be used to accommodate the correct size of stack of papers to be stapled.

It is thus an object of the present invention to provide a desktop stapler that requires a low operating force and is easy to use.

A further object of the present invention is to reduce the cost and increase the convenience of stapling by providing a single stapler that meets all of the user's stapling needs.

Further objects, features and advantages will become apparent upon consideration of the following detailed description of the invention when taken in conjunction with the drawings and the appended claims.

### BRIEF DESCRIPTION OF THE DRAWINGS

The attached figures depict various embodiments of the invention.

FIG. 1 is a sectional view of a desktop stapler according to the present invention, shown in a substantially horizontal orientation as it would sit upon a desktop;

FIG. 2 is a perspective view of a staple cartridge according to the present invention; and

FIG. 3 is a side view showing the insertion of the staple cartridge of FIG. 2 into the desktop stapler of FIG. 1.

### DETAILED DESCRIPTION OF THE INVENTION

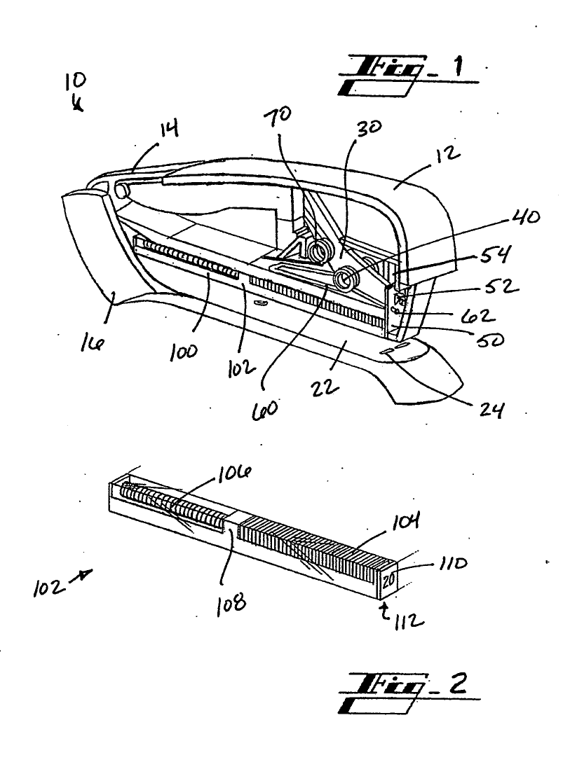

FIG. 1 is a sectional view of a desktop stapler 10 according to the present invention, shown in a substantially horizontal orientation as it would sit upon a desktop. The stapler 10 comprises a handle 12 pivotably connected to a housing body 14. A base 16 is pivotably connected to the housing body 14 at a hinge connection. The base 16 includes a base plate 22 having an anvil 24 for bending the legs of a staple, the anvil being formed in a known manner to present two anvil grooves in which the free ends of the legs of a staple passing through the material to be stapled are either spread apart or brought together, in a known manner.

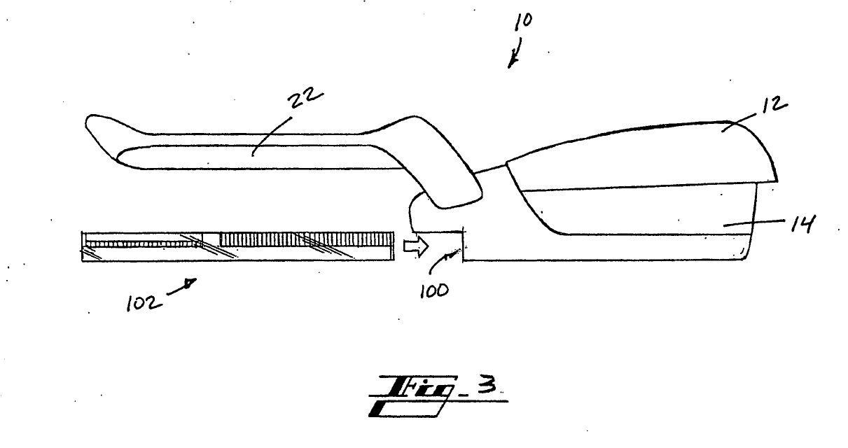

The housing body 14 includes a chamber 100 for receiving a staple cartridge 102. With reference to FIG. 2, the staple cartridge 102 comprises a staple track for a strip of staples 104, a tension spring 106, and a sliding block 108. The staples 104 are located in the staple track such that the staples 104 are pushed forward by the sliding block 108 which is linked with the tension spring 106. When a staple is located at a stopping plate 110, the staple is ready to be ejected out of the cartridge 102 through a staple ejecting slot 112.

With reference to FIG. 1, within the housing body 14, a lever 30 pivots about a pin at a slot 40. A front end of the lever 30 extends through a slot 52 in a center portion of a staple driver 50. A tab may be provided on the lever 30 as an engagement surface upon which handle 12 can press. The driver 50 is fitted along two edges in guide channels 54 of the housing 14.

A power spring 60 stores energy for ejecting staples. Spring 60 is linked to the handle 12 through the lever 30 and to the driver 50. The lever 30 pivots about the pin at the slot 40 to raise the driver 50 at the front end of the lever 30. The rising driver 50 in turn deflects the front end of the spring 60 up by a linkage to the spring at openings 62. In the illustrated embodiment, the handle 12 moves downward at its front end about 0.9 inch. This is approximately double that possible with a direct action stapler where the handle is directly linked to the driver. The increased handle travel provides additional leverage to deflect the spring 60, thus allowing reduced handle force. The spring 60 is preferably a double torsion spring, with co-axial helical coils to each side of the lever 30, with the coils linked at a rear end. Two front ends of the double torsion spring fit into the openings 62 below and to each side of the slot 52. The lever 30 is “nested” within the spring, between the coils of the spring 60, so that the assembly of the lever 30 and the spring 60 are vertically compact. The lever 30 passes between the coils. The pin extends through both the slot 40 of the lever 30 and the coil of the spring 60. The lever 30 pivots about an axis defined at the pin in slot 40.

In use, as the handle 12 is forced downward the handle 12 moves the lever 30 quickly with low leverage at the start of the stroke. At the end of the stroke, the leverage of the handle 12 is relatively higher upon lever 30. At the same time the force required to deflect the spring 60 increases as the driver 50 is lifted. Because the leverage provided by the handle increases through the stroke, the net force required to operate the handle is relatively constant, with no hard-to-overcome peak at the end from a highly deflected spring 60.

At the end of the stroke, the front end of the lever 30 is just out of the plane defined by driver 50, and is no longer engaged with the slot 52. The driver 50 is free to accelerate downward under the stored energy of the spring 60, to eject a staple.

As the handle 12 is lifted after ejection of a staple, a re-set spring 70 is biased to rotate the lever 30 so that the front end of the lever 30 moves down into alignment with the slot 52 of the driver during a re-set stroke. The rear end of the lever 30 moves upward as the lever 30 pivots about the pin at slot 40. The re-set spring 70 includes features at each end to hold the spring 70 in place. During the re-set stroke, the handle 12 rotates upward from the bias of the re-set spring 70.

With reference to FIG. 3, the staple cartridge 102 is installed into the chamber 100 via an opening 120 adjacent the rear of the housing body 14. The opening 120 is accessed by rotating the housing body 14 to an upside down and rearward extending position behind the base 22. Accordingly, the mechanism used for loading the staple cartridge 102 is not visible until it is needed.

In accordance with the present invention, to staple a stack of paper having a different size, a user may simply replace the staple cartridge 102 with a second staple cartridge having staples of a different length, rather than being required to use a separate stapler. Further, the user may switch between a plurality of disposable, pre-loaded staple cartridges based on the user's stapling needs. For example, a first staple cartridge may be provided that includes staples for stapling a stack of a maximum of 30 sheets, a second staple cartridge may be provided that includes staples for stapling a stack of a maximum of 60 sheets, and a third staple cartridge may be provided that includes staples for stapling a stack of a maximum of 90 sheets.

While this invention has been described with reference to preferred embodiments thereof, it is to be understood that variations and modifications can be affected within the spirit and scope of the invention as described herein and as described in the appended claims.

What is claimed is:

1. A desktop stapler comprising:
a. a handle pivotably connected to a housing body;
b. a base pivotably connected to the housing body;
c. a spring within the housing body, wherein the spring is linked to the handle via a lever and to a staple driver; and
d. a chamber within the housing body, wherein the chamber is adapted to receive one of a set of interchangeable staple cartridges.
